(19) United States
(12) Patent Application Publication
(10) Pub. No.: US 2014/0060072 A1
(43) Pub. Date: Mar. 6, 2014

(54) METHOD OF STARTING A GAS TURBINE SYSTEM

(71) Applicants: Steven William Backman, Simpsonville, SC (US); Michael Bull, Ingelheim Am Rhein (DE); Markus Feigl, Simpsonville, SC (US); Stephen Kent Fulcher, Greenville, SC (US)

(72) Inventors: Steven William Backman, Simpsonville, SC (US); Michael Bull, Ingelheim Am Rhein (DE); Markus Feigl, Simpsonville, SC (US); Stephen Kent Fulcher, Greenville, SC (US)

(73) Assignee: General Electric Company, Schenectady, NY (US)

(21) Appl. No.: 13/603,030

(22) Filed: Sep. 4, 2012

(51) Int. Cl. F02C 7/26

(52) U.S. Cl. 60/778

(57) ABSTRACT

A method of starting a gas turbine system is provided. The method includes approximating a temperature of at least one turbine system component. Also included is selectively determining a flow rate for a fuel to be delivered to a combustor for combustion therein, wherein the flow rate is dependent upon the temperature of the at least one turbine system component. Further included is delivering the fuel to the combustor at the flow rate selectively determined.

### BACKGROUND OF THE INVENTION

The subject matter disclosed herein relates to gas turbine systems, and more particularly to a method of starting a gas turbine system.

Reliable starting of the gas turbine system includes successful “light-off” of a fuel, such as a liquid fuel. Successful light-off is dependent upon an appropriate level of firing fuel flow during a firing attempt, among other things. Overall, firing occurs inside an envelope of a maximum allowable firing time and a maximum allowable amount of fuel. Typically, a single constant firing fuel flow setting is employed during a starting process, however, a variety of factors associated with the starting process may lead to different firing fuel flow settings being beneficial. In such a way, various firing fuel flow settings may lead to more efficient and reliable starting processes based on the number of factors alluded to above.

### BRIEF DESCRIPTION OF THE INVENTION

According to one aspect of the invention, a method of starting a gas turbine system is provided. The method includes approximating a temperature of at least one turbine system component. Also included is selectively determining a flow rate for a fuel to be delivered to a combustor for combustion therein, wherein the flow rate is dependent upon the temperature of the at least one turbine system component. Further included is delivering the fuel to the combustor at the flow rate selectively determined.

According to another aspect of the invention, a method of starting a gas turbine system is provided. The method includes determining a temperature of a turbine system component. Also included is determining whether the temperature is within a first range, a second range or a third range. Further included is delivering a fuel to a combustor at a first fuel flow rate if the temperature is within the first range. Yet further included is delivering the fuel to the combustor at a second fuel flow rate if the temperature is within the second range. Also included is delivering the fuel to the combustor at a third fuel flow rate if the temperature is within the third range, wherein the third range is between the first range and the second range.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings in which:

FIG. 1 is a schematic illustration of a gas turbine system;

FIG. 2 graphically illustrates a temperature of a turbine system component over a duration of time subsequent to flame-out of the gas turbine system;

FIG. 3 is a flow diagram illustrating a method of starting the gas turbine system according to a first embodiment;

FIG. 4 graphically illustrates a flow rate to be employed during starting of the gas turbine system as a function of the temperature of the turbine system component according to the first embodiment;

FIG. 5 is a flow diagram illustrating the method of starting the gas turbine system according to a second embodiment; and

FIG. 6 graphically illustrates a flow rate to be employed during starting of the gas turbine system as a function of the temperature of the turbine system component according to the second embodiment.

The detailed description explains embodiments of the invention, together with advantages and features, by way of example with reference to the drawings.

### DETAILED DESCRIPTION OF THE INVENTION

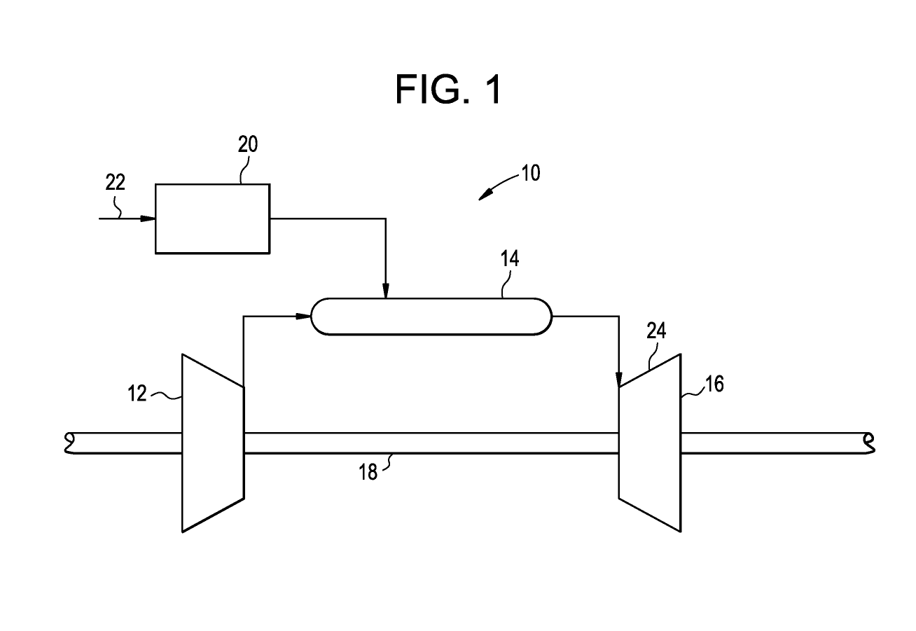

Referring to FIG. 1, a gas turbine system is schematically illustrated with reference numeral 10. The gas turbine system 10 includes a compressor 12, a combustor 14, a turbine 16, a shaft 18 and a fuel nozzle 20. It is to be appreciated that one embodiment of the gas turbine system 10 may include a plurality of compressors 12, combustors 14, turbines 16, shafts 18 and fuel nozzles 20. The compressor 12 and the turbine 16 are coupled by the shaft 18. The shaft 18 may be a single shaft or a plurality of shaft segments coupled together to form the shaft 18.

The combustor 14 uses a combustible liquid and/or gas fuel, such as natural gas or a hydrogen rich synthetic gas, to run the gas turbine system 10. For example, fuel nozzles 20 are in fluid communication with an air supply and a fuel supply 22. The fuel nozzles 20 create an air-fuel mixture, and discharge the air-fuel mixture into the combustor 14, thereby causing a combustion that creates a hot pressurized exhaust gas. The combustor 14 directs the hot pressurized gas through a transition piece into a turbine nozzle (or “stage one nozzle”), and other stages of buckets and nozzles causing rotation of the turbine 16 within a turbine casing 24. Rotation of the turbine 16 causes the shaft 18 to rotate, thereby compressing the air as it flows into the compressor 12.

An embodiment of the gas turbine system 10, and more specifically the combustor 14, employing liquid fuel for combustion purposes requires the provision of liquid fuel to the combustor 14 for combustion therein. The liquid fuel is supplied at various flow rates that are dependent upon various parameters associated with the gas turbine system 10, such as the temperature of one or more turbine system components. Successful “light-off” of liquid fuel is dependent upon an appropriate flow rate of liquid fuel during a firing attempt of the gas turbine system 10. To reliably produce successful light-off, various parameters, such as temperature as noted above, are taken into account to determine the appropriate flow rate of liquid fuel to be provided during the firing attempt. Generally speaking, during a relatively “cold start,” a greater flow rate of fuel is appropriate, when compared to a relatively “hot start.” This is based on the increased likelihood of a “choking out” of a combustor flame if too much fuel is supplied during the hot firing attempt. Conversely, during a colder start, too low of a flow rate will result in a diminished likelihood of successful light-off.

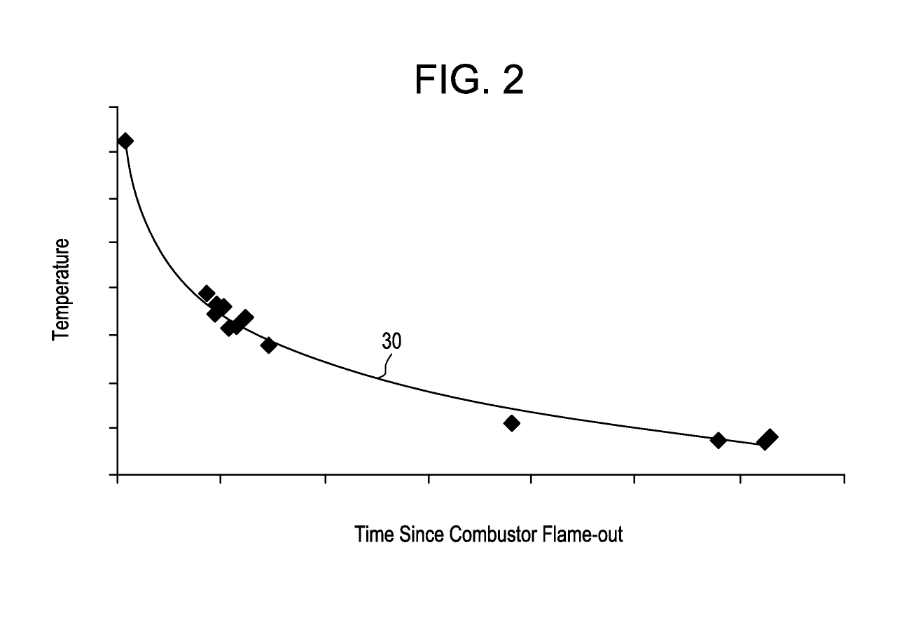

Referring now to FIG. 2, it is to be appreciated that the terms “cold start” and “hot start” refer to temperature within the combustor 14, however, an accurate temperature reading within the combustor 14 is typically difficult to obtain. Therefore, the temperature of various other turbine system components may be employed as a reference to determine the thermal state of the gas turbine system 10, and more particularly the combustor 14. Collection of empirical data provides temperatures of at least one turbine system component, as well as how such temperatures decrease subsequent to shutdown of the gas turbine system 10. As illustrated, the temperature of a given gas turbine component will decrease as a function of time according to a logarithmic function 30 that may be fitted to the empirical data gathered.

The at least one turbine system component employed to make the thermal determination of the gas turbine system 10 may include a variety of gas turbine components. Examples of components or regions of the gas turbine system 10 that may be employed include the combustor 14, a compressor inlet region, a compressor discharge region, a turbine section exhaust region, an outer casing of the turbine 16 or the compressor 12, and the wheel space of the turbine 16, such as the first stage wheel space that is disposed proximate an outlet of the combustor 14. It is to be understood that the preceding examples are merely illustrative and are not intended to be limiting of components and/or regions that may be employed to determine the thermal state of the gas turbine system 10.

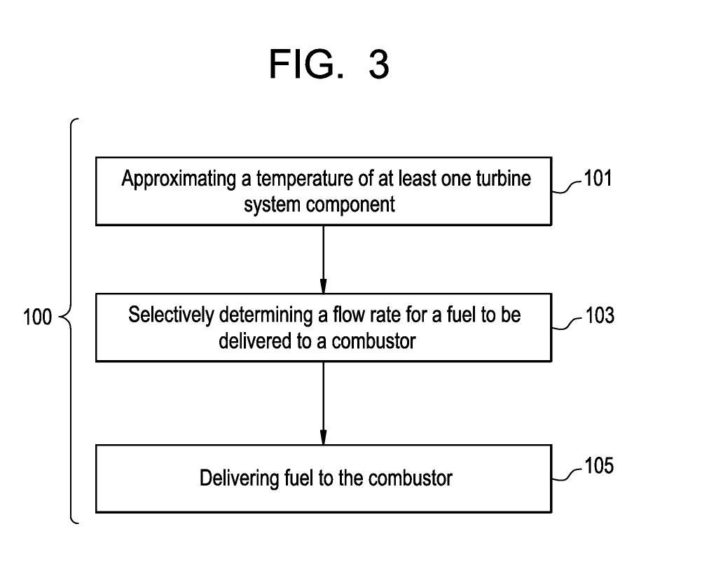

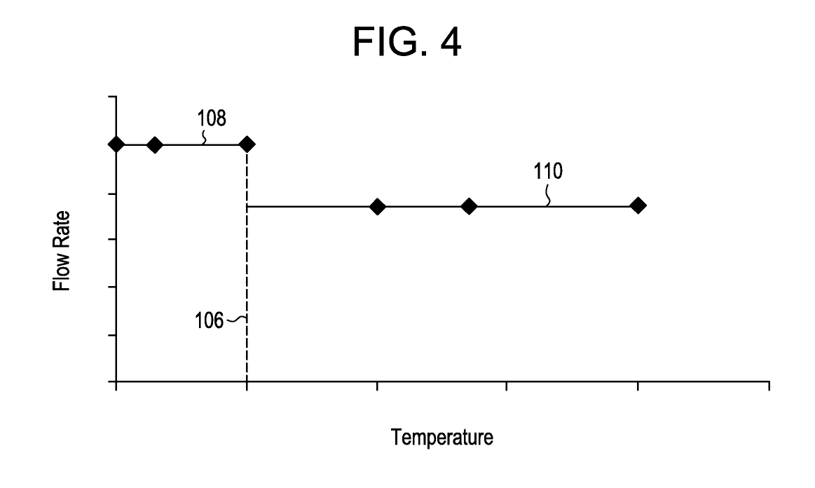

Referring now to FIGS. 3 and 4, a method of starting a gas turbine system 100 according to a first embodiment is illustrated. The method includes approximating a temperature of at least one turbine system component 101. As described above, various components may be employed to make the approximation and may be based on an instant thermal reading or inferred based on available empirical data. The method of starting a gas turbine system 100 also includes selectively determining a flow rate for a fuel to be delivered 103 to the combustor 14. As described in detail above, the flow rate is dependent upon the temperature of the at least one turbine system component. Subsequent to selectively determining a flow rate for a fuel to be delivered 103, the fuel is then delivered to the combustor 105.

As illustrated, the first embodiment includes determining whether the temperature of the at least one turbine system component is above or below a predetermined temperature 106. The predetermined temperature 106 corresponds to a temperature that delineates a cold start and a hot start. A first flow rate 108 or a second flow rate 110 is selected based on the determination of whether the at least one turbine system component is above or below the predetermined temperature 106. The first flow rate 108 corresponds to a cold start, where the temperature of the at least one turbine system component is below the predetermined temperature 106. Conversely, the second flow rate 110 corresponds to a hot start, where the temperature of the at least one turbine system component is above the predetermined temperature 106. As shown, the first flow rate 108 is greater than the second flow rate 110, based on the above-described desirability to provide more liquid fuel during a cold firing attempt than during a hot firing attempt.

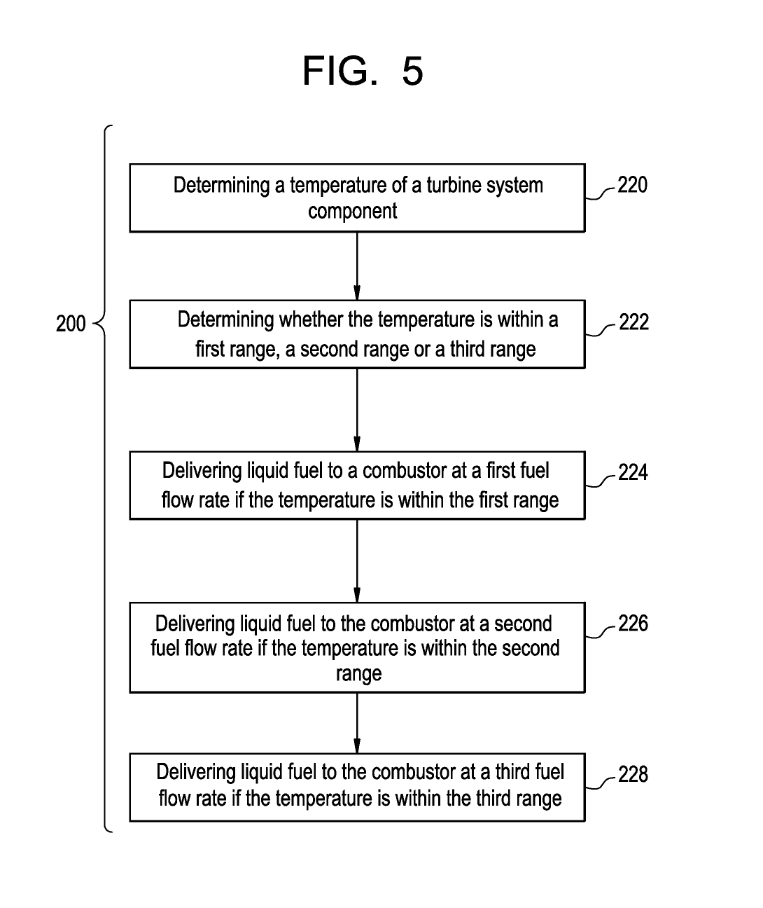

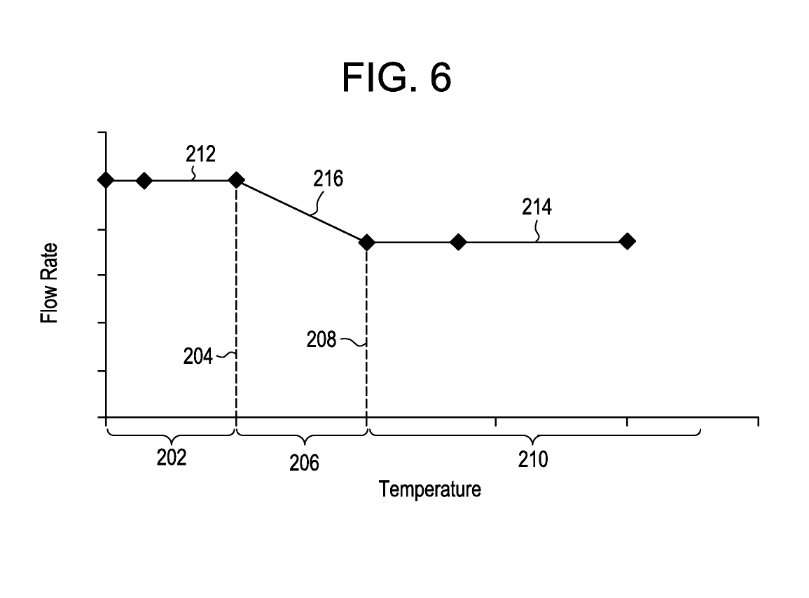

Referring now to FIGS. 5 and 6, a method of starting a gas turbine system 200 according to a second embodiment is illustrated. The method of starting a gas turbine system 200 of the second embodiment is similar to the first embodiment described above, but rather than simply delineating two constant flow rates based on the predetermined temperature 106, such as the first flow rate 108 and the second flow rate 110, the second embodiment comprises three temperature regions. Specifically, a first range 202 is defined as lower than a first predetermined temperature 204, a second range 206 is defined as greater than a second predetermined temperature 208, and a third range 210 is defined between the first range 202 and the second range 206, and more particularly between the first predetermined temperature 204 and the second predetermined temperature 208. In the illustrated embodiment, a first fuel flow rate 212 is selected if the temperature of the at least one turbine system component is within the first range 202. Similarly, a second fuel flow rate 214 is selected if the temperature of the at least one turbine system component is within the second range 206. It is noted that the first fuel flow rate 212 and the second fuel flow rate 214 are constant over the first range 202 and the second range 206, respectively. In contrast, a third fuel flow rate 216 that is variable based on temperature is determined and selected if the temperature of the at least one turbine system component is within the third range 210.

As noted above, the third fuel flow rate 216 is variable and is a function of temperature. The third range 210 defines a range of temperatures that are not characterized as hot or cold and the varying rate of liquid fuel delivered at temperatures over the third range 210 increases efficiency of the gas turbine system 10, and more particularly the combustion process by increasing the reliability of successful light-off of the fuel during the firing attempt. Rather than providing a constant flow rate over the third range 210, the third fuel flow rate 216 is a function of temperature and may be of a linear variance. The precise flow rates over the third range 210 may be linearly interpolated between the first range 202 and the second range 206 or may be empirically determined.

Irrespective of the method of determining the precise flow rates comprising the third fuel flow rate 216 over the third range 210, the flow diagram of FIG. 5 illustrates the second embodiment. Specifically, the method of starting a gas turbine system 200 includes determining a temperature of a turbine system component 220 and determining whether the temperature is within a first range, a second range or a third range 222. Subsequently, liquid fuel is delivered to a combustor at a first fuel flow rate if the temperature is within the first range 224, a second fuel flow rate if the temperature is within the second range 226, and a third fuel flow rate if the temperature is within the third range 228. While the method has been described in a particular order, it is to be appreciated that the method may be carried out in distinct orders as that outlined above.

Advantageously, an efficient and reliable firing fuel flow is selected based on determining the state (i.e., thermal condition) of the gas turbine system 10 at firing and employing a firing fuel flow rate based on the state of the gas turbine system 10. Such a system and method reduces cost and reliability problems of liquid fuel fired gas turbine systems during starting procedures.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method of starting a gas turbine system comprising:
approximating a temperature of at least one turbine system component;
selectively determining a flow rate for a fuel to be delivered to a combustor for combustion therein, wherein the flow rate is dependent upon the temperature of the at least one turbine system component; and
delivering the fuel to the combustor at the flow rate selectively determined.

2. The method of claim 1, further comprising:
delivering the fuel at a first flow rate if the temperature of the at least one turbine system component is below a predetermined temperature; and
delivering the fuel at a second flow rate if the temperature of the at least one turbine system component is above a predetermined temperature.

3. The method of claim 1, further comprising determining if the temperature of the at least one turbine system component is within a first range, a second range or a third range.

4. The method of claim 3, further comprising:
delivering the fuel at a first fuel flow rate if the temperature of the at least one turbine system component is within the first range;
delivering the fuel at a second fuel flow rate if the temperature of the at least one turbine system component is within the second range; and
delivering the fuel at a third fuel flow rate if the temperature of the at least one turbine system component is within the third range, wherein the third range is between the first range and the second range.

5. The method of claim 4, further comprising selectively determining the third fuel flow rate by linearly interpolating between the first fuel flow rate and the second fuel flow rate as a function of temperature.

6. The method of claim 1, wherein the fuel is a liquid fuel.

7. The method of claim 1, wherein the at least one turbine system component is proximate a first stage wheel space of a turbine section of the gas turbine system.

8. The method of claim 1, wherein the at least one turbine system component is proximate an inlet region of a compressor of the gas turbine system.

9. The method of claim 1, wherein the at least one turbine system component is proximate a discharge region of a compressor of the gas turbine system.

10. The method of claim 1, wherein the at least one turbine system component is proximate an exhaust region of a turbine section of the gas turbine system.

11. The method of claim 1, wherein the at least one turbine system component is proximate an outer casing of turbine section of the gas turbine system.

12. A method of starting a gas turbine system comprising:
determining a temperature of a turbine system component;
determining whether the temperature is within a first range, a second range or a third range;
delivering a fuel to a combustor at a first fuel flow rate if the temperature is within the first range;
delivering the fuel to the combustor at a second fuel flow rate if the temperature is within the second range; and
delivering the fuel to the combustor at a third fuel flow rate if the temperature is within the third range, wherein the third range is between the first range and the second range.

13. The method of claim 12, further comprising selectively determining the third fuel flow rate by linearly interpolating between the first fuel flow rate and the second fuel flow rate as a function of temperature.

14. The method of claim 12, wherein the fuel is a liquid fuel.

15. The method of claim 12, wherein the turbine system component is proximate a first stage wheel space of a turbine section of the gas turbine system.

16. The method of claim 12, wherein the turbine system component is proximate an inlet region of a compressor of the gas turbine system.

17. The method of claim 12, wherein the turbine system component is proximate a discharge region of a compressor of the gas turbine system.

18. The method of claim 12, wherein the turbine system component is proximate an exhaust region of a turbine section of the gas turbine system.

19. The method of claim 12, wherein the turbine system component is proximate an outer casing of turbine section of the gas turbine system.
